(19) United States
(12) Patent Application Publication
(10) Pub. No.: US 2025/0148559 A1
(43) Pub. Date: May 8, 2025

(54) System and Method for Providing Legally Binding Documents for Liability Waivers Between Authenticated Users

(71) Applicants: Glenn Kramer, Merritt Island, FL (US); Steven J. Paris, Newtown Grant, PA (US)

(72) Inventors: Glenn Kramer, Merritt Island, FL (US); Steven J. Paris, Newtown Grant, PA (US)

(21) Appl. No.: 19/015,422

(22) Filed: Jan. 9, 2025

Related U.S. Application Data
(63) Continuation-in-part of application No. 17/322,825, filed on May 17, 2021, now abandoned.

(51) Int. Cl. G06Q 50/18; G06K 19/06

(52) U.S. Cl. CPC G06Q 50/18; G06K 19/06037

(57) ABSTRACT

A system and method for generating legally binding liability waivers and agreements between authenticated users via a mobile application. Designed for a broad range of use cases, including family entertainment centers, high-risk outdoor activities, car accidents, and social dating, the app streamlines document creation through QR code scanning and digital signature capture. Users can instantly generate, execute, and securely store agreements with verified identification and timestamps. The system offers enhanced security features, multi-language support, call center assistance, and a network of independent attorneys for legal consultation. With robust cloud integration and scalable architecture, it ensures efficient storage and retrieval of agreements for statutory periods. Future expansion includes customizable modules for additional legal use cases, further enhancing the app's versatility across various sectors. This innovative solution simplifies legal processes, reduces administrative overhead, and provides users with reliable protection in everyday transactions.

### FEDERALLY SPONSORED RESEARCH

Not Applicable

### SEQUENCE LISTING OR PROGRAM

Not Applicable

### TECHNICAL FIELD OF THE INVENTION

The present invention relates generally to electronically signed documents. More specifically, the present invention relates to providing documents between authenticated users for the release of liability.

### BACKGROUND OF THE INVENTION

Currently there is a need for liability protection for at the consumer level for individuals in a variety of situations. Obtaining liability waivers for yard sale items, minor person to person incidents, or even independent contractors in the home is inconvenient for both parties.

While consumers can obtain free liability waivers from website, there is no guarantee that the waivers are accurate or correct for their situation and meet local laws. Additionally, there is the issue of verify and authenticating any parties that may sign a document, and providing and retaining copies of such a document should the future need arise for its use.

Therefore, what is needed is a software application designed to function on any number of different software platforms such as APPLE'S IOS or ANDROID, that can not only operate and be compatible with various software platforms, but also operate easily across multiple mobile hardware devices.

Additionally, what is needed is a consumer level liability protection application that provides for user authentication between parties, provides readily executable liability waivers and other contractual documents, as well as storing and distributing copies of the document and additional documentation such a photos and videos to all parties that eliminates the need for paper copies, wet signatures, and anything physical beyond a mobile electronic device such as a smart phone, tablet, PDA, etc.

### Definitions

Unless stated to the contrary, for the purposes of the present disclosure, the following terms shall have the following definitions:

Administrators, commonly known as admins or sysops (system operators), are software or system users who have been granted the technical ability to perform certain special actions.

“Application software” is a set of one or more programs designed to carry out operations for a specific application. Application software cannot run on itself but is dependent on system software to execute. Examples of application software include MS Word, MS Excel, a console game, a library management system, a spreadsheet system etc. The term is used to distinguish such software from another type of computer program referred to as system software, which manages and integrates a computer's capabilities but does not directly perform tasks that benefit the user. The system software serves the application, which in turn serves the user.

The term “app” is a shortening of the term “application software”. It has become very popular and in 2010 was listed as “Word of the Year” by the American Dialect Society

“Apps” are usually available through application distribution platforms, which began appearing in 2008 and are typically operated by the owner of the mobile operating system. Some apps are free, while others must be bought. Usually, they are downloaded from the platform to a target device, but sometimes they can be downloaded to laptops or desktop computers.

“API” In computer programming, an application programming interface (API) is a set of routines, protocols, and tools for building software applications. An API expresses a software component in terms of its operations, inputs, outputs, and underlying types. An API defines functionalities that are independent of their respective implementations, which allows definitions and implementations to vary without compromising each other.

A client is a piece of computer hardware or software that accesses a service made available by a server. The server is often (but not always) on another computer system, in which case the client accesses the service by way of a network. The term applies to programs or devices that are part of a client-server model.

“Electronic Mobile Device” is defined as any computer, phone, smartphone, tablet, or computing device that is comprised of a battery, display, circuit board, and processor that is capable of processing or executing software. Examples of electronic mobile devices are smartphones, laptop computers, and tablet PCs.

A gateway is a link between two computer programs or systems. A gateway acts as a portal between two programs allowing them to share information by communicating between protocols on a computer or between dissimilar computers.

“GUI”. In computing, a graphical user interface (GUI) sometimes pronounced “gooey” (or “gee-you-eye”)) is a type of interface that allows users to interact with electronic devices through graphical icons and visual indicators such as secondary notation, as opposed to text-based interfaces, typed command labels or text navigation. GUIs were introduced in reaction to the perceived steep learning curve of command-line interfaces (CLIs), which require commands to be typed on the keyboard.

The Hypertext Transfer Protocol (HTTP) is an application protocol for distributed, collaborative, hypermedia information systems. HTTP is the foundation of data communication for the World Wide Web. Hypertext is structured text that uses logical links (hyperlinks) between nodes containing text. HTTP is the protocol to exchange or transfer hypertext.

The internet of things, or IoT, is a system of interrelated computing devices, mechanical and digital machines, objects, animals or people that are provided with unique identifiers (UIDs) and the ability to transfer data over a network without requiring human-to-human or human-to-computer interaction.

The Internet Protocol (IP) is the principal communications protocol in the Internet protocol suite for relaying datagrams across network boundaries. Its routing function enables internetworking, and essentially establishes the Internet.

An Internet Protocol address (IP address) is a numerical label assigned to each device (e.g., computer, printer) participating in a computer network that uses the Internet Protocol for communication. An IP address serves two principal functions: host or network interface identification and location addressing.

An Internet service provider (ISP) is an organization that provides services for accessing, using, or participating in the Internet.

iOS (originally iPhone OS) is a mobile operating system created and developed by Apple Inc. and distributed exclusively for Apple hardware. It is the operating system that presently powers many of the company's mobile devices, including the iPhone, iPad, and iPod touch.

A “mobile app” is a computer program designed to run on smartphones, tablet computers and other mobile devices, which the Applicant/Inventor refers to generically as “a computing device”, which is not intended to be all inclusive of all computers and mobile devices that are capable of executing software applications.

A “mobile device” is a generic term used to refer to a variety of devices that allow people to access data and information from wherever they are. This includes cell phones and other portable devices such as, but not limited to, PDAs, Pads, smartphones, and laptop computers.

A “module” in software is a part of a program. Programs are composed of one or more independently developed modules that are not combined until the program is linked. A single module can contain one or several routines or steps.

A “module” in hardware, is a self-contained component.

An operating system (OS) is software that manages computer hardware and software resources and provides common services for computer programs. The operating system is an essential component of the system software in a computer system. Application programs usually require an operating system to function.

Push Notification, Push, or server push describes a style of Internet-based communication where the request for a given transaction is initiated by the publisher or central server. It is contrasted with pull/get, where the request for the transmission of information is initiated by the receiver or client.

QR code (abbreviated from Quick Response code) is the trademark for a type of matrix barcode (or two-dimensional barcode) first designed in 1994 for the automotive industry in Japan. A barcode is a machine-readable optical label that contains information about the item to which it is attached.

A server is a running instance of an application (software) capable of accepting requests from the client and giving responses accordingly. Servers can run on any computer including dedicated computers, which individually are also often referred to as “the server”.

“SMS” (short message service) is a text messaging service component of most telephone, internet, and mobile-device systems. It uses standardized communication protocols to enable mobile devices to exchange short text messages.

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used. A software module is defined as a series of process steps stored in an electronic memory of an electronic device and executed by the processor of an electronic device such as a computer, pad, smart phone, or other equivalent device known in the prior art.

A “software application module” is a program or group of programs designed for end users that contains one or more files that contains instructions to be executed by a computer or other equivalent device.

A “smartphone” (or smart phone) is a mobile phone with more advanced computing capability and connectivity than basic feature phones. Smartphones typically include the features of a phone with those of another popular consumer device, such as a personal digital assistant, a media player, a digital camera, and/or a GPS navigation unit. Later smartphones include all of those plus the features of a touchscreen computer, including web browsing, wideband network radio (e.g. LTE), Wi-Fi, 3rd-party apps, motion sensor and mobile payment.

URL is an abbreviation of Uniform Resource Locator (URL), it is the global address of documents and other resources on the World Wide Web (also referred to as the “Internet”).

A “User” is any person registered to use the computer system executing the method of the present invention.

In computing, a “user agent” or “useragent” is software (a software agent) that is acting on behalf of a user. For example, an email reader is a mail user agent, and in the Session Initiation Protocol (SIP), the term user agent refers to both end points of a communications session. In many cases, a user agent acts as a client in a network protocol used in communications within a client-server distributed computing system. In particular, the Hypertext Transfer Protocol (HTTP) identifies the client software originating the request, using a “User-Agent” header, even when the client is not operated by a user. The SIP protocol (based on HTTP) followed this usage.

A “web application” or “web app” is any application software that runs in a web browser and is created in a browser-supported programming language (such as the combination of JavaScript, HTML and CSS) and relies on a web browser to render the application.

A “website”, also written as Web site, web site, or simply site, is a collection of related web pages containing images, videos or other digital assets. A website is hosted on at least one web server, accessible via a network such as the Internet or a private local area network through an Internet address known as a Uniform Resource Locator (URL). All publicly accessible websites collectively constitute the World Wide Web.

A “web page”, also written as webpage is a document, typically written in plain text interspersed with formatting instructions of Hypertext Markup Language (HTML, XHTML). A web page may incorporate elements from other websites with suitable markup anchors.

Web pages are accessed and transported with the Hypertext Transfer Protocol (HTTP), which may optionally employ encryption (HTTP Secure, HTTPS) to provide security and privacy for the user of the web page content. The user's application, often a web browser displayed on a computer, renders the page content according to its HTML markup instructions onto a display terminal. The pages of a website can usually be accessed from a simple Uniform Resource Locator (URL) called the homepage. The URLs of the pages organize them into a hierarchy, although hyperlinking between them conveys the reader's perceived site structure and guides the reader's navigation of the site,

### SUMMARY OF THE INVENTION

The system and method of the present invention is a software application that focuses exclusively on incidents where a civil liability is created, and an entity is at legal risk. The software app will assess the situation and generate a legal document that establishes a Waiver of Liability and/or a Hold Harmless provision for the entity at risk. The document will be executed through the software app using a mobile electronic device or computer, the identity of the parties and signatures will be verified on both sides, and the document retained by the software app using cloud storage should litigation be initiated surrounding the circumstances of the incident or transaction. The document retention period would conform to the statute of limitations, or any period beyond that depending on previously defined data retention policies.

The system of the present invention provides the users with a legal document that holds them harmless and waives liability should adverse outcomes occur during a specific event, transaction, or incident with a second-party regardless of the cause.

The software app must is free to download, easy for all parties to enroll, and simple to operate from a smartphone. The operation of the application is first initialed when an individual (“user”) downloads the app and enrolls. Enrollment requires identification, contact information, plan selection for a single event or subscription, and response to several qualifying questions required to verify identity.

Once enrolled, a QR code is generated that keys critical information and enables the user to create a Hold Harmless/Waiver of Liability agreement with a second-party. The QR code is a unique identifier.

Next, the user will initiate an incident/event that requires an agreement with a second-party. The user, or first party, will open the app, either input descriptive information or use drop down boxes. The second-party will be required to download the app and enroll as a second-party. If successful, a QR code will be generated as their unique identifier.

The user will scan the second-party QR and generate the agreement. The software will display relevant information on one or both smartphones for review. Both parties will be asked “do you agree?” If yes, agreement is verified, and the system records and timestamps the event.

The document created by the system includes specific references to a group of specific liability situations (e.g. and injury); causal actions (fault); culpability (Percent contribution of each party); loss level (physical and/or financial); state of occurrence; and both parties must acknowledge that they fully understand what they are signing.

The system will retain the terms and conditions of the agreement until the statute of limitations has elapsed. Each party to the transaction can access the agreement through the app at any time and the record of the agreement will be easily locatable by each party on their app if ever needed in the future.

### BRIEF DESCRIPTION OF THE DRAWINGS

The accompanying drawings, which are incorporated herein form a part of the specification, illustrate the present invention and, together with the description, further explain the principles of the invention and to enable a person skilled in the pertinent art to make and use the invention.

FIG. 1 is flow chart of the software application, specifically detailing the enrollment, QR code generation as unique identifiers, and document creation.

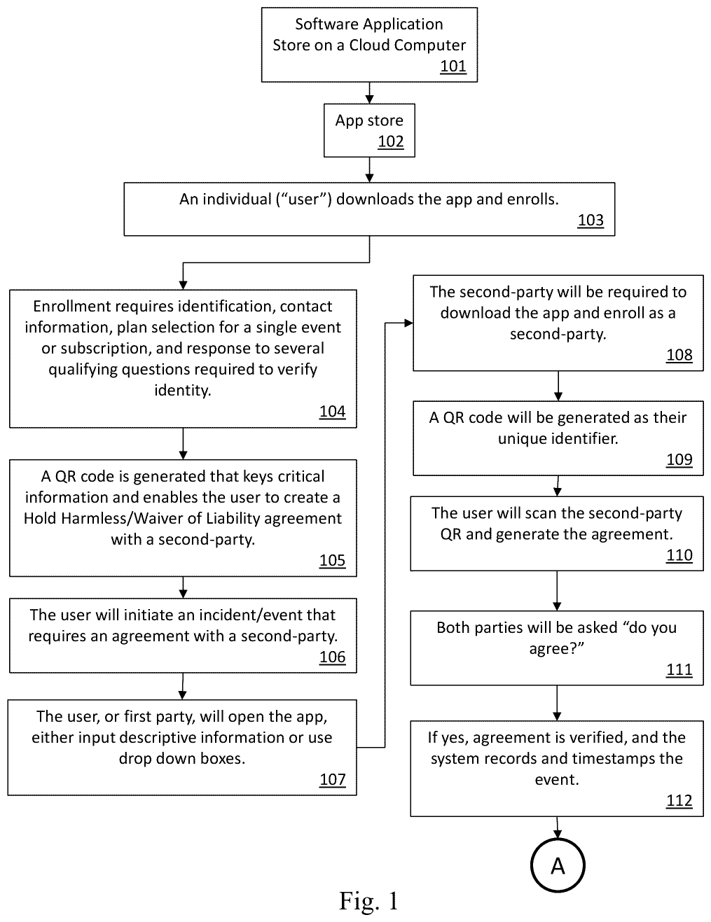

FIG. 2 is a flow chart illustrating the display, storage, and recall steps provided by the software application and system of the present invention after a document is created and executed by the parties.

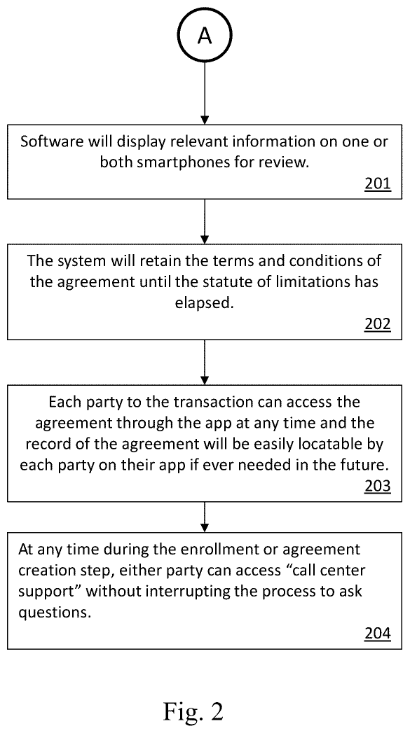

FIG. 3 is a flowchart illustrating the specifications for a document generation as taught by the system and method of the present invention.

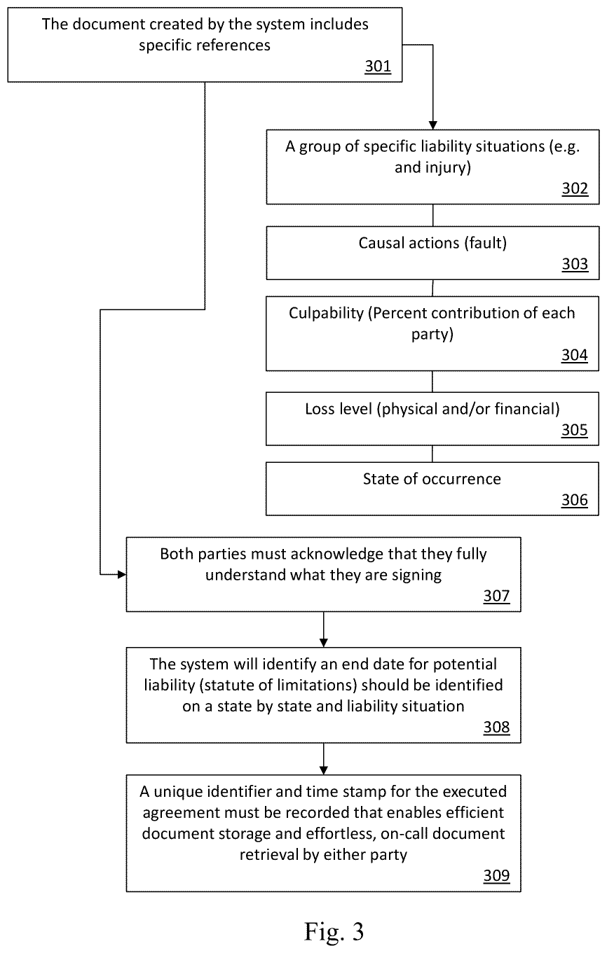

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The system and method of the present invention is a software application that focuses exclusively on incidents where a civil liability is created, and an entity is at legal risk. The software app will assess the situation and generate a legal document that establishes a Waiver of Liability and/or a Hold Harmless provision for the entity at risk. The document will be executed through the software app using a mobile electronic device or computer, the identity of the parties and signatures will be verified on both sides, and the document retained by the software app using cloud storage should litigation be initiated surrounding the circumstances of the incident or transaction. The document retention period would conform to the statute of limitations, or any period beyond that depending on previously defined data retention policies.

Large corporations have extensive user agreements and liability protections that a customer must agree to as a condition for a transaction. These corporations also maintain general and product liability insurance that will cover legal exposure in the event of litigation. For corporations, maintaining legal and insurance protections are significant and essential expense items precipitated by our highly litigious society.

Individuals, independent contractors, and small business owners, however, do not generally have the financial resources or legal expertise to adequately protect their assets should they be sued by a party for an incident or transaction that had an unfavorable outcome. The software app of the present invention was conceived for this population.

Several scenarios illustrate the utility of the software application of the present invention, but the illustrative scenarios are exemplary in nature and do not over all possible application and situations that the application may be executed to cover.

Individuals encounter incidents daily where there are elevated risks of liability and varying degrees of legal protection.

In a first scenario, a homeowner needs work done and wants to hire an individual (“handyman”) or a contractor. The homeowner may ask for proof of insurance but even if presented, unless coverage is verified, the actual risk and exposure is unknown. One adverse event is the worker could get injured. If the homeowner has homeowner's insurance, there may be coverage after a deductible.

An injured individual may incur medical expense, loss of use, and seek State Worker's Comp if a prolonged rehabilitation. The homeowner is a target whether the injured party was 100% at fault and in the current litigious state of our society, the worker will find an attorney to handle assert their position/allegation and cause the homeowner undue emotion and financial stress that could have and should have been avoided.

In a similar situation, if an injured worker is working under a contractor, the homeowner would not normally verify immigration status, employment or sub-contract agreement, or work comp and other insurance coverage for all workers. The risk and exposure are unknown at the time the homeowner contracts the work.

In a second scenario, an individual allows a third-party to borrow their car or lets the third-party use their lawn mower. At the time the friendly transaction occurs, the individual probably does not know if any of their insurance coverage will indemnify or minimize loss in the event the car crashes and people are injured or the lawn mower cuts off the borrower's foot. Again, it is almost a guaranteed that the individual will be sued whether the borrower was 100% at fault or not in causing the injury.

In a third scenario, independent contractors who provide personal services such as nail techs, hair stylists, personal trainers, and masseuses, among others have a liability risk every time they touch a customer. Though States may require licensing, certification, and minimum liability insurance coverage, legal and financial risk is an afterthought until there is an adverse event. A customer could get sick or have an infection, hair could fall out, or a rotator cuff could become injured during a training session. These are complex issues in the event a provider is sued but this could be avoided or mitigated by a simple software application and binding legal agreement on liability.

Such a legal document should identify critical disclosures, so the aggrieved party knows exactly how proficient and certified their independent contractor is when they agree to services. Under those circumstances, whether the independent contractor was 100% at fault, the accepting party must agree to fully indemnify the service provider and accept 100% of the risk.

In a fourth scenario, small business owners that prepare, serve, and/or distribute homemade food or beverage items have a product liability risk on every transaction whether they serve retail or wholesale their product. A buyer may presume that the business owner has obtained the required State licenses and Food Handling certification, and their production facility has been inspected, and they carry adequate product liability insurance but, often they discover after an adverse event (like a food borne illness) that their presumption was wrong.

Like the independent contractor scenario, critical disclosures in a liability waiver document would establish risk for the consumer and acceptance would shift 100% of the risk back to the consumer regardless of whose negligence may have caused the adverse situation.

Café or restaurant service is higher profile and potentially lower risk. Negative media coverage and bad reviews can kill a business if unsafe sanitary conditions cause illness, but a liability waiver document signed at the point-of-service could mitigate the risk of being sued. Hold harmless provisions may help these small businesses reduce insurance premiums.

Having thought through several scenarios and customer types who would derive value from using a liability waiver, the range of liabilities where an “ironclad” document can afford the user exceptional protection include, but are not limited to,: Workplace or home injury, Product liability, Errors & Omissions-consultants may want this protection, Worker's Comp liability—may not be possible given State regulations. (Criminal exposure is probable.), Fraudulent causes of action, Civil and Criminal culpability based on third-party conduct (e.g. a contractor), UCC liens that arise from inferior or incomplete work, Regulatory/Compliance risk—culpability or complicity with a third-party who is non-compliant, Malicious reputation threats —actually, an offensive action (future liability waiver document enhancement?), and Ponzi scheme protection-potential to mitigate claw-backs.

The system of the present invention provides the users with a legal document that holds them harmless and waives liability should adverse outcomes occur during a specific event, transaction, or incident with a second-party regardless of the cause. The cost for this protection is not significant given the potential financial risk. The user is assured that: The document contains State-specific language that delineates the liability and includes disclosures that shift the risk and liability to the second-party and signatures are verified on both sides and the document will be recognized by a State court as legitimate. The system of the present invention provides call center support to answer questions during document preparation and execution. The system of the present invention maintains a network of independent attorneys in each State should a user want professional counsel. The system of the present invention guarantees protection and will advocate on behalf of the user should a legal action be initiated. Indemnification will continue until the statute of limitations has elapsed.

The software app must is free to download and is stored on a cloud computer 101, easy for all parties to enroll, and simple to operate from a smartphone. The software application will be available in the GOOGLE and APPLE stores 102 as a standard mobile application. The operation of the application is first initialed when an individual (“user”) downloads the app and enrolls 103. Enrollment requires identification, contact information, plan selection for a single event or subscription, and response to several qualifying questions required to verify identity 104.

Once enrolled, a QR code is generated that keys critical information and enables the user to create a Hold Harmless/Waiver of Liability agreement with a second-party 105. The QR code is a unique identifier.

Next, the user will initiate an incident/event that requires an agreement with a second-party 106. The user, or first party, will open the app, either input descriptive information or use drop down boxes 107. The second-party will be required to download the app and enroll as a second-party 108. If successful, a QR code will be generated as their unique identifier 109.

The user will scan the second-party QR and generate the agreement 110. The software will display relevant information on one or both smartphones for review. Both parties will be asked “do you agree?” 111. If yes, agreement is verified, and the system records and timestamps the event 112.

Software will display relevant information on one or both smartphones for review 201. The system will retain the terms and conditions of the agreement until the statute of limitations has elapsed 202. Each party to the transaction can access the agreement through the app at any time and the record of the agreement will be easily locatable by each party on their app if ever needed in the future 203. At any time during the enrollment or agreement creation step, either party can access “call center support” without interrupting the process to ask questions 204.

The document created by the system includes specific references 301 to a group of specific liability situations (e.g. and injury) 302; causal actions (fault) 303; culpability (Percent contribution of each party) 304; loss level (physical and/or financial) 305; state of occurrence 306; and both parties must acknowledge that they fully understand what they are signing 307.

Additionally, the system will identify an end date for potential liability by applying statute of limitations identified on a state by state and liability situation 308. A unique identifier and time stamp for the executed agreement must be recorded that enables efficient document storage and effortless, on-call document retrieval by either party 309.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The system and method of the present invention can be utilized effectively in family entertainment centers, such as trampoline parks, indoor climbing gyms, go-kart racing venues, and other recreational facilities that require patrons to sign release of liability waivers prior to participation. Traditionally, patrons must spend significant time at the entrance manually filling out waiver forms, which can cause delays and inconvenience to both the patrons and the venue staff. By integrating the present invention, family entertainment centers can offer a streamlined process where patrons simply scan a QR code specific to the venue upon arrival. The software app instantly generates a legally binding release document tailored to the activities offered at the venue. Each patron's identity is authenticated, and their electronic signature is recorded. This reduces wait times, increases efficiency, and enhances the overall customer experience.

High-risk outdoor activities such as skydiving, river rafting, bungee jumping, target shooting, and similar adventure sports typically require participants to sign detailed liability waivers and provide proof of identification. The present invention can simplify and enhance this process by enabling quick, digital generation and execution of waivers. By deploying unique QR codes at each activity site, participants can use their mobile devices to scan the code, fill out necessary information, and electronically sign the waiver. This ensures accurate record-keeping and instant verification of participant identities. Additionally, the app can store completed waivers for easy retrieval by both parties in the event of a legal dispute, ensuring that the documentation is always accessible.

In the event of a car accident, exchanging information between the involved parties is crucial. Many individuals find it challenging to properly document and exchange information, especially when law enforcement is not present. The present invention can assist by providing an automated solution where users can generate a legally binding agreement that records the details of the accident. Each party can use the app to input their information, scan each other's QR codes, and generate a document that captures critical data such as names, contact details, insurance information, and a description of the incident. The agreement is timestamped and stored securely, allowing both parties to access it at any time. This process eliminates the need for paper forms and ensures that all necessary information is accurately captured.

Another novel application of the present invention involves providing legal protection in the context of social dating. In scenarios where individuals engage in consensual activities, there can be situations where misunderstandings or disputes arise. The present invention can be adapted to allow users to create a consensual engagement document by scanning each other's QR codes through the app. The document would include mutually agreed terms and conditions, ensuring that both parties have a clear understanding of their intentions. This document, once signed and authenticated by both parties, would be stored securely in the cloud and accessible to either party if needed in the future. Such a feature can provide an additional layer of protection and clarity in social interactions.

To support these new applications, the system of the present invention may incorporate additional features such as multi-factor authentication (MFA) to further enhance user identity verification. Additionally, venue-specific or activity-specific templates for liability waivers can be pre-loaded into the system to facilitate rapid document generation. The app can also offer translation services for venues that cater to international clients, ensuring that documents are available in multiple languages.

The enhanced system can be scaled to support a large number of users and venues through robust cloud integration. Each venue or activity provider can maintain a unique profile on the platform, allowing them to customize their waiver templates, terms, and conditions. The cloud storage feature ensures that all documents are securely retained for the required statutory period, with easy access and retrieval options for both users and providers.

To further improve user confidence and satisfaction, the present invention includes call center support available 24/7. Users can contact the support team at any stage of the process, whether during document creation, signing, or retrieval. Additionally, for complex situations that may require professional legal advice, the system maintains a network of independent attorneys in each state. Users can opt to consult with an attorney directly through the app, ensuring they receive expert guidance tailored to their specific needs.

The present invention is designed with modularity in mind, allowing for future expansion into other areas where legally binding agreements may be required. Potential future applications include rental agreements for equipment, personal property, and temporary real estate leases. Each new module can be seamlessly integrated into the existing platform, leveraging the app's core functionality of user authentication, document generation, and secure cloud storage.

The system is set to run on a computing device or mobile electronic device. A computing device or mobile electronic device on which the present invention can run would be comprised of a CPU, storage device, keyboard, monitor or screen, CPU main memory and a portion of main memory where the system resides and executes. Any general-purpose computer, smartphone, or other mobile electronic device with an appropriate amount of storage space is suitable for this purpose. Computer and mobile electronic devices like these are well known in the art and are not pertinent to the invention. The system can also be written in several different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

1. A method for providing legally binding documents for liability waivers between authenticated users comprising the steps of:
downloading a software application from an application store to a mobile electronic device; enrolling as a user in the software application;
generating a QR code uniquely identifying the user; initiating an event requiring a waiver with a second-party; and
creating a Hold Harmless/Waiver of Liability agreement with a second-party.

2. The method of claim 1, wherein the software application enables users to scan venue-specific QR codes to generate tailored waivers at family entertainment centers.

3. The method of claim 1, wherein the software application allows users to scan QR codes deployed at high-risk outdoor activity sites to create activity-specific liability waivers.

4. The method of claim 1, further comprising the step of enabling users involved in a car accident to exchange information by scanning each other's QR codes and generating a legally binding agreement.

5. The method of claim 1, wherein the software application allows users to create consensual engagement agreements for social dating by scanning QR codes and mutually agreeing on terms.

6. The method of claim 1, further comprising the step of storing generated waivers securely in a cloud environment accessible by both parties.

7. The method of claim 1, further comprising the step of timestamping executed waivers and associating them with unique identifiers for efficient retrieval.

8. The method of claim 1, wherein the software application includes multi-factor authentication (MFA) to enhance user identity verification during enrollment and agreement creation.

9. The method of claim 1, wherein the software application supports multiple languages for waiver creation and execution.

10. The method of claim 1, further comprising the step of pre-loading venue-specific or activity-specific waiver templates to facilitate rapid document generation.

11. The method of claim 1, further comprising the step of providing real-time call center support during the waiver creation process.

12. The method of claim 1, further comprising the step of offering access to a network of independent attorneys for professional legal consultation.

13. The method of claim 1, wherein the software application allows small business owners to create liability waivers for food and beverage transactions.

14. The method of claim 1, further comprising the step of enabling users to customize waiver terms and conditions based on specific events or activities.

15. The method of claim 1, wherein the software application supports scalability for large-scale deployment across multiple venues and activity providers.

16. The method of claim 1, further comprising the step of determining liability end dates based on state-specific statutes of limitations.

17. The method of claim 1, further comprising the step of enabling modular integration of future applications such as rental agreements and temporary real estate leases.

18. The method of claim 1, wherein the software application enables users to attach additional documentation such as photos or videos to the generated waiver.

19. The method of claim 1, further comprising the step of integrating a digital signature verification mechanism to ensure the authenticity of executed waivers.

20. The method of claim 1, further comprising the step of allowing users to generate and execute waivers offline, with automatic synchronization to the cloud when connectivity is restored.
